(19) United States
(12) Patent Application Publication
(10) Pub. No.: US 2026/0346772 A1
(43) Pub. Date: Nov. 5, 2026

(54) EQUIPMENT PART FOR A VEHICLE SEAT, IN PARTICULAR HEAD RESTRAINT FOR A VEHICLE SEAT

(71) Applicant: Adient US LLC, Plymouth, MI (US)

(72) Inventors: Miroslav REZBARIK, Trencin (SK); Mikuláš PTAŠINSKÝ, Velka Hradná (SK)

(21) Appl. No.: 19/662,490

(22) Filed: Apr. 29, 2026

(30) Foreign Application Priority Data
Apr. 30, 2025 (DE) 10 2025 116 778.8

(51) Int. Cl. B60N 2/818

(52) U.S. Cl. CPC B60N 2/818

(57) ABSTRACT

An equipment part for a vehicle seat may have a base and a slide part. The slide part may be lockable by a locking device. The locking device may have a locking element which has at least one tooth and is movable relative to the base, and at least two latching depressions which are formed on, or fastened to, the slide part. In a locked state, the at least one tooth engages in one of the at least two latching depressions and, in an unlocked state, the at least one tooth is disengaged from the latching depressions. The locking element may have at least one locking pin, and the base has a recess corresponding to the at least one locking pin. A head restraint, embodied as an equipment part, where the base is fixable to a backrest of the vehicle seat by a holding device, is also provided.

### FIELD

The invention relates to an equipment part for a vehicle seat, in particular a head restraint for the vehicle seat, the equipment part having a base and a slide part movable relative to the base in at least one direction of movement, wherein the slide part is lockable in at least two positions relative to the base in at least one direction of movement by means of a locking device, the locking device having a locking element which has at least one tooth and is movable relative to the base, and at least two latching depressions which are formed on the slide part or fastened to the slide part, wherein, in a locked state of the locking device, the at least one tooth engages in one of the at least two latching depressions and, in an unlocked state of the locking device, the at least one tooth is disengaged from the latching depressions. The invention moreover relates to a head restraint.

### BACKGROUND

Known from WO 2019/238516 A1 is a height-adjustable head restraint, comprising a main support element and a support element which is disposed therein and guidable so as to be displaceable in a longitudinal direction, wherein for forming a guide the main support element comprises a number of openings and the support element comprises a number of guide parts, wherein a shape of the number of openings corresponds to a shape of the number of guide parts.

DE 10 2021 130 160 B4 discloses an equipment part for a vehicle, having a base and a part movable relative to the base, wherein the movable part in terms of at least one direction of movement is lockable in at least two positions relative to the base by means of a locking device, wherein the locking device comprises at least one recess, wherein, in a locked position of the locking device at least one safety latch engages in one of the recesses, and in a release position the safety latch is disengaged from the recess.

### SUMMARY

The invention is based on the object of improving an equipment part for a vehicle of the type mentioned at the outset, in particular of increasing the locking strength of a locking device of the equipment part, and by means of such an equipment part to provide a strength-optimized head restraint.

This object is inventively achieved by an equipment part for a vehicle seat, in particular a head restraint for the vehicle seat, the equipment part having a base and a slide part movable relative to the base in at least one direction of movement, wherein the slide part is lockable in at least two positions relative to the base in at least one direction of movement by means of a locking device, the locking device having a locking element which has at least one tooth and is movable relative to the base, and at least two latching depressions which are formed on the slide part or fastened to the slide part, wherein, in a locked state of the locking device, the at least one tooth engages in one of the at least two latching depressions and, in an unlocked state of the locking device, the at least one tooth is disengaged from the latching depressions, wherein the locking element, in addition to the at least one tooth, has at least one locking pin, and the base has a recess corresponding to the at least one locking pin, wherein, in the locked state of the locking device, the at least one locking pin is arranged in the recess, and in the unlocked state of the locking device, the at least one locking pin is arranged outside the recess.

A tooth is understood to be any suitable element which is designed to fit into a corresponding latching depression, thus positively blocking and/or locking a movement in at least one direction of movement. The at least one tooth can be a tooth of a straight-cut toothing. The at least one tooth can be a tooth of an involute toothing. The at least one tooth can be a bolt. The at least one tooth can be symmetrical. The at least one tooth can be non-symmetrical. A latching depression is presently understood to be a three-dimensional depression which is suitable to block and/or lock in a form-fitting manner a movement of at least one tooth in at least one direction of movement.

A locking pin is understood to mean any suitable element which is designed to fit into a corresponding recess and thus positively blocks and/or locks a movement in at least one direction of movement. The at least one locking pin can be a bolt. The at least one locking pin can be symmetrical. The at least one locking pin can be non-symmetrical. The at least one locking pin can have a round cross section. The at least one locking pin can have an oval cross section. The at least one locking pin can have a polygonal cross section. A recess is presently understood to be a three-dimensional depression which is suitable for blocking or locking in a form-fitting manner a movement of the at least one locking pin in at least one direction of movement. The recess can be a depression. The recess can be an opening.

The equipment part can be a head restraint, for example. The equipment part can be a seat depth adjustment, for example. The equipment part can be a calf support, for example.

Owing to the fact that the locking element, in addition to the at least one tooth, has at least one locking pin, and the base has a recess corresponding to the at least one locking pin, wherein, in the locked state of the locking device, the at least one locking pin is arranged in the recess, and in the unlocked state of the locking device, the at least one locking pin is arranged outside the recess, the locking element has an additional form-fitting support in the base. The force to be absorbed by the locking element thereby generates, in particular, lower bending stresses in the locking element. This can alternatively increase the locking strength of the locking device and/or reduce the dimensions (and thus cost and weight) of the locking element.

A refinement provides that the at least one locking pin is arranged parallel to the at least one tooth and adjacent to the latter. In particular, the at least one locking pin and the at least one tooth are formed integrally, in particular as an integral locking element. As a result, the locking element is formed with a double locking mechanism - one on the base and one on the slide - in a manner which is simple, saves installation space and is optimized in terms of assembly.

For example, the base can have at least one guide opening in which the slide part is movably guidable or guided. For example, the guide opening can of a U-shaped design. Alternatively, a plurality of, in particular two, guide openings can be provided, which are formed so as to be mutually parallel and mutually spaced apart in the base.

Additionally, the base can have a linear guide in which the locking element is movably guidable or guided. Preferably, the at least one guide opening and the linear guide are arranged so as to be mutually perpendicular. In other words: The at least one guide opening extends in the longitudinal direction, in particular in the direction of movement, and the linear guide extends perpendicularly thereto in the vertical direction, in particular in the locking direction or the unlocking direction.

Moreover, the linear guide can be arranged centrally in the at least one guide opening, in particular in a U-shaped guide opening, or between two guide openings. This enables a particularly compact construction of the equipment part.

The locking element can be guided in a linear guide of the base so as to be longitudinally displaceable in a locking direction and in an unlocking direction counter to the locking direction. By displacing the locking element in the locking direction, the locking device can be transferable to the locked state. By displacing the locking element in the unlocking direction, the locking device can be transferable to the unlocked state.

The locking element can have a main body which is guided so as to be longitudinally displaceable in the linear guide of the base. The slide part may have a through hole. The locking element, at least in the locked state of the locking device, can protrude through the through hole of the slide part in such a manner that the main body is arranged on a first side of the through hole, and that at least one locking pin is at least partially arranged on an opposite second side of the through hole. The through hole can be an elongate bore. The elongate bore can be aligned parallel to the direction of movement. Due to the through hole being an elongate bore, the locking pin can protrude through the through hole in different relative positions between the slide part and the base.

The locking element can have a plurality of teeth. Each of the teeth can be assigned exactly one row of a plurality of rows of latching depressions. The locking element can have exactly two teeth, wherein each of the two teeth are assigned exactly one row of latching depressions. The at least one locking pin can be arranged centrally between a plurality of teeth. The at least one locking pin can be arranged centrally between exactly two teeth. Depending on the relative position between the slide part and the base, the teeth drop into different latching depressions of the rows of latching depressions, potentially only after the slide part is slightly shifted relative to the base, so that the teeth can drop deep into the latching depressions.

The at least one locking pin can protrude through a through hole designed as an elongate bore. At least one row of a plurality of rows of latching depressions can in each case be arranged on both sides of the through hole. The at least one locking pin can, in particular in a locking direction, protrude beyond the at least one tooth. In particular, a pin end of the at least one locking pin protrudes beyond a tooth end of the at least one tooth.

A guide, in particular a linear guide, can be provided between the base and the slide part which is movable relative to the base in at least one direction of movement. For forming the guide, the base can have at least one guide opening, and the slide part can have at least one guide part, wherein the at least one guide part is guided so as to be displaceable in the at least one guide opening. The base can have two guide openings which each receive and guide a guide part of the slide part. The two guide openings can be connected to one another, in particular by a web.

According to the invention, the object is moreover achieved by a head restraint for a vehicle seat, embodied as an equipment part according to the invention, wherein the base is fixable to a backrest of the vehicle seat by means of a holding device. The base can be firmly fixable to the backrest of the vehicle seat by means of the holding device. The base can be fixable to the backrest of the vehicle seat so as to be height-adjustable by means of the holding device.

The holding device may have at least one head restraint bar. The at least one head restraint bar can be made from a round stock. The at least one head restraint bar can be made from a wire. The wire can have a round cross section. The wire can have an oval cross section. The wire can have a polygonal cross section. The holding device can have two head restraint bars. The holding device can have a holding bracket. The holding bracket can be U-shaped. The holding bracket can be made from a round stock. The holding bracket can be made from a wire. The wire can have a round cross section. The wire can have an oval cross section. The wire can have a polygonal cross section.

The slide part of the head restraint can be connected to a head support part. The head support part can provide rearward support to a head of an occupant of the vehicle seat. The head support part can be fixedly connected to the slide part. The head support part can be clipped to the slide part. The head support part can be screwed to the slide part. The head support part and the slide part can be made integrally. The head support part can be connected to the slide part by means of kinematics. The kinematics can be used to adjust the inclination of the head support part.

The locking element can be preloaded by means of an arrestor spring in a locking direction, so that the locked state of the locking device is secured by the arrestor spring. By means of an in particular manually operable unlocking element, the locking element, in particular while overcoming a spring force of the arrestor spring, can be movable in an unlocking direction until the unlocked state of the locking device is reached.

In summary, and in other words, the invention provides an improved locking mechanism for a movable mechanism. In comparison to the prior art, in particular a head restraint known from WO 2019/238516 A1, a slide part with a base in an upper region is additionally lockable without additional components or without an extended sliding path of a locking element. The locking element additionally engages in an upper region of the base. The base can be a fixed component. The slide part can be a movable component which slides in the base and by way of which the locking element is lockable in a defined position. The slide part can be constructed conjointly with a front plate (head support part), or be made separately and connected to the front plate and, potentially, a rear cover (lid). This improved locking action was achieved by a special design of the locking element designed as a central lock, which has an extended central region (locking pin) for interacting with the base and an elongate bore in the slide part. The elongate bore in the slide part allows a direct connection between a linear guide for the slide part in the base and an opening in an upper region of the base for the locking pin via the locking element. This connection provides a high-strength locking action of the slide part in the base for high loads. To achieve a better load distribution, the locking element can have at least one tooth on a left side and on a right side of the locking pin.

### DESCRIPTION OF THE FIGURES

In the following, the invention is explained in more detail with reference to an advantageous exemplary embodiment illustrated in the figures. However, the invention is not limited to this exemplary embodiment. In the figures:

FIG. 1: schematically shows a lateral view of a vehicle seat, having an equipment part according to the invention designed as a head restraint,

FIG. 2: shows an exploded illustration of an equipment part according to the invention designed as a head restraint,

FIG. 3: shows a perspective view of a locking element of the head restraint from FIG. 2,

FIG. 4: shows a lower view of a slide part of the head restraint from FIG. 2,

FIG. 5: shows a perspective view of the slide part from FIG. 4 and of the locking element from FIG. 3, wherein the locking element is in a position that locks the slide part,

FIG. 6: shows a further perspective view of the slide part from FIG. 4 and of the locking element from FIG. 3, wherein the locking element is in a position that locks the slide part,

FIG. 7: shows a longitudinal section through the slide part from FIG. 4 and the locking element from FIG. 3, wherein the locking element is in a position that locks the slide part,

FIG. 8: shows a perspective view of a base of the head restraint from FIG. 2,

FIG. 9: shows a perspective view of the base from FIG. 8 and of the locking element from FIG. 3, wherein the locking element is in a position that locks the slide part,

FIG. 10: shows a longitudinal section through the base from FIG. 8 and the locking element from FIG. 3, wherein the locking element is in a position that locks the slide part,

FIG. 11: shows a front view of the head restraint from FIG. 2,

FIG. 12A: shows a section through the head restraint along the line A-A in FIG. 11, wherein a locking device of the head restraint is in a locked state and a head support part is in a rear position,

FIG. 12B: shows a section through the head restraint along the line B-B in FIG. 11, wherein the locking device is in a locked state and a head support part is in a rear position,

FIG. 13A: shows a section through the head restraint along the line A-A in FIG. 11, wherein the locking device is in an unlocked state and a head support part is in a rear position,

FIG. 13B: shows a section through the head restraint along the line B-B in FIG. 11, wherein the locking device is in an unlocked state and a head support part is in a rear position,

FIG. 14A: shows a section through the head restraint along the line A-A in FIG. 11, wherein the locking device is in an unlocked state and a head support part is in a front position, and

FIG. 14B: shows a section through the head restraint along the line B-B in FIG. 11, wherein the locking device is in an unlocked state and a head support part is in a front position.

### DETAILED DESCRIPTION

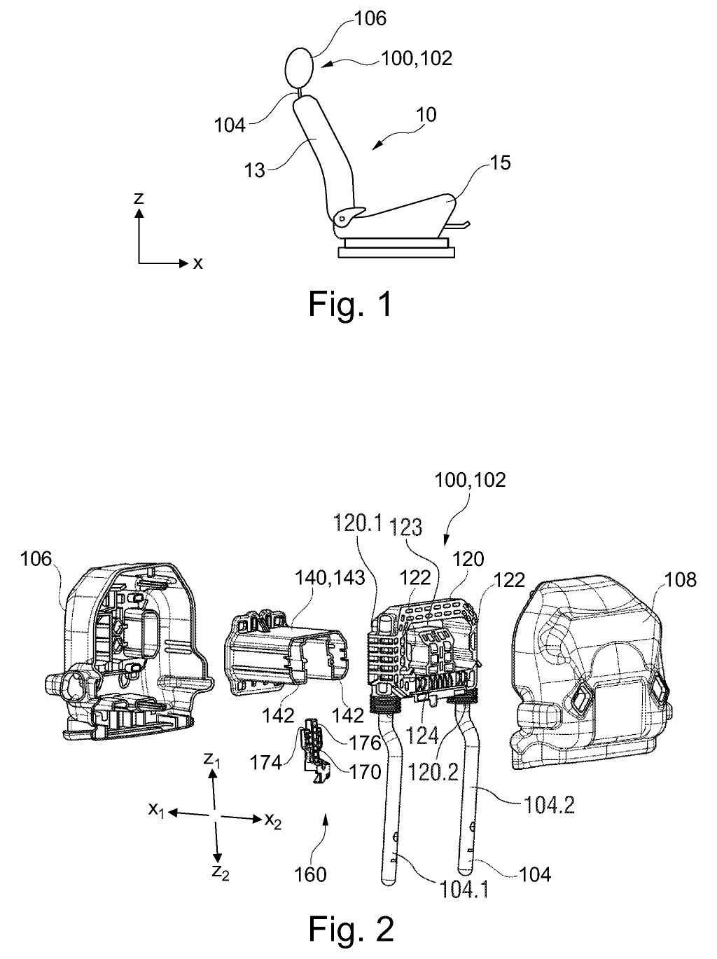

FIG. 1 schematically shows a vehicle seat 10 with an equipment part 100 according to the invention, which is embodied as a head restraint 102. The vehicle seat 10 comprises a backrest 13 and a seat part 15. The head restraint 102 is attached to the upper edge of the backrest 13 by means of a holding device 104.

The vehicle seat 10 will be described hereunder while using three mutually perpendicular spatial directions. In a vehicle seat 10 installed in the vehicle, a longitudinal direction x extends largely horizontally and preferably parallel to a vehicle longitudinal direction, the latter corresponding to the normal direction of travel of the vehicle. A transverse direction perpendicular to the longitudinal direction x is also aligned to be horizontal in the vehicle and extends parallel to a vehicle transverse direction. A vertical direction z extends perpendicularly to the longitudinal direction x and perpendicularly to the transverse direction. In a vehicle seat 10 installed in the vehicle, the vertical direction z extends parallel to the vehicle vertical axis.

The position and direction information used, for example, front, rear, top and bottom, refer to a viewing direction of an occupant seated in the vehicle seat 10 in the normal seating position, wherein the vehicle seat 10 is installed in the vehicle, in a use position suitable for transporting passengers, with an upright backrest 13, and aligned as usual in the direction of travel.

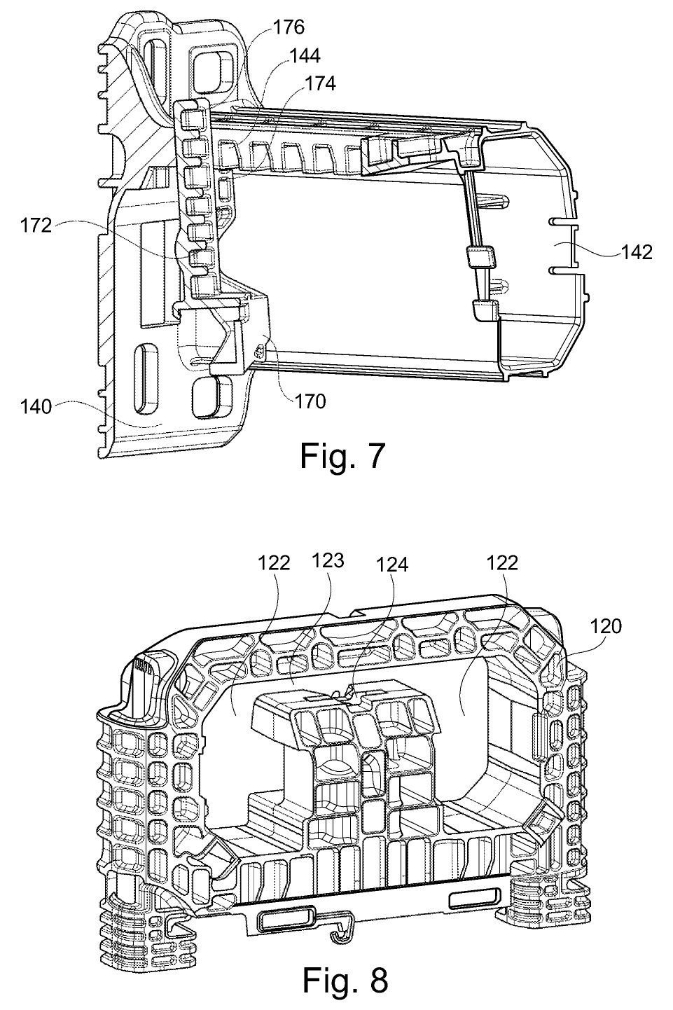

The equipment part 100 according to the invention, which is illustrated in FIGS. 2-14B and is embodied as a head restraint 102, is described in more detail hereunder. However, the invention is not limited to this exemplary embodiment.

As can be seen, for example, in the exploded illustration of FIG. 2, the head restraint 102 has a base 120, a slide part 140, a locking device 160 with a locking element 170, a head support part 106 and a lid 108.

The base 120 is fastenable to the backrest 13 by means of the holding device 104 formed as two head restraint bars 104.1, 104.2. Instead of head restraint bars 104.1, 104.2, a head restraint bracket can also be provided. For receiving and fastening the head restraint bars 104.1, 104.2, the base 120 on each external side comprises holding openings 120.1, 120.2.

The slide part 140 is guided so as to be longitudinally displaceable relative to the base 120 in a first direction of movement x₁, and in a second direction of movement x₂ counter to the first direction of movement x₁. To form the guide, the base 120 has at least one guide opening 122, preferably two guide openings 122, and the slide part 140 has two corresponding guide parts 142. The two guide parts 142 are guided so as to be movable, in particular displaceable, in the at least one, in particular U-shaped, guide opening (not illustrated) or in the two guide openings 122 (illustrated). The plurality of, in particular two, guide openings 122 are preferably formed to be mutually parallel and mutually spaced apart in the base 120. Moreover, they can be connected by a through opening formed as a slot 123.

The first direction of movement x₁ and the second direction of movement x₂ are co-aligned and differ only by orientations that are 180 degrees opposite. The first direction of movement x₁ is oriented approximately towards the front. The second direction of movement x₂ is oriented approximately towards the rear. The longitudinal direction x and the first direction of movement x₁ can be mutually parallel or extend at an acute angle relative to one another.

The head support part 106 is fastened, presently clipped and/or screwed, to the slide part 140. The head support part 106 serves to support a head of an occupant of the vehicle seat 10 towards the rear. The head support part 106 can be covered with a padding. The lid 108 screens the head restraint 102 from the rear. The lid 108 is fastened, presently clipped and/or screwed, to the head support part 106.

The slide part 140 is lockable in a plurality of different positions relative to the base 120 by means of the locking device 160. This allows a spacing between the head support part 106 and the head of the occupant to be adjusted.

The locking device 160 has a locking element 170 which is movable relative to the base 120. The locking element 170 is guided in a linear guide 124 (shown in FIG. 8) of the base 120 so as to be longitudinally displaceable in a locking direction z₁ and in an unlocking direction z₂ counter to the locking direction z₁. The locking direction z₁ and the unlocking direction z₂ are co-aligned and differ only by orientations that are 180 degrees opposite. The locking direction z₁ is oriented approximately upwards. The unlocking direction z₂ is oriented approximately downwards. The vertical direction z and the locking direction z₁ can be mutually parallel or extend at an acute angle relative to one another.

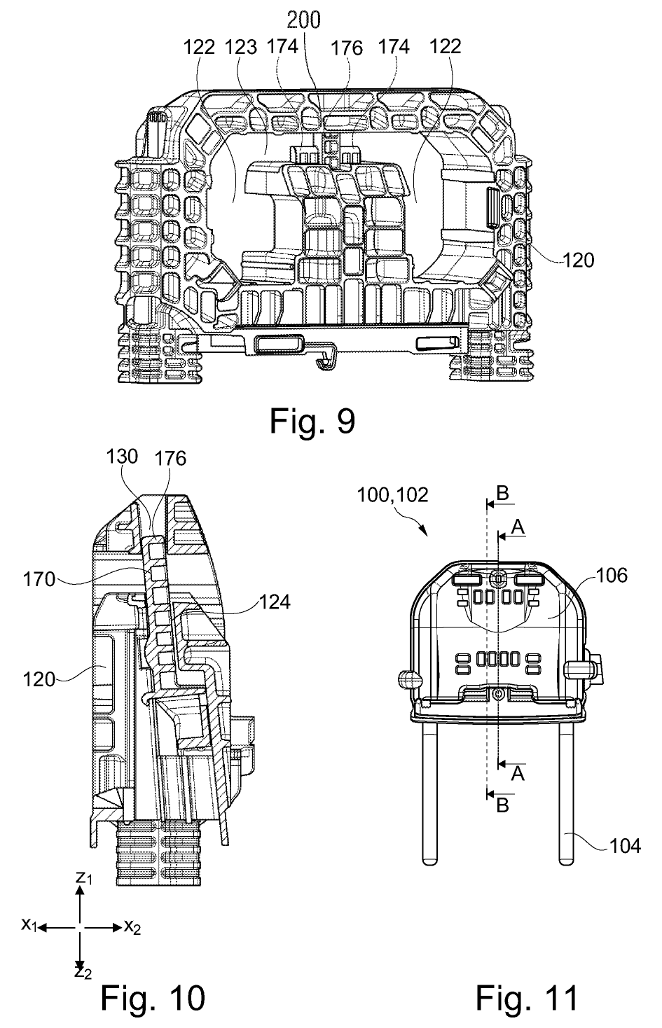

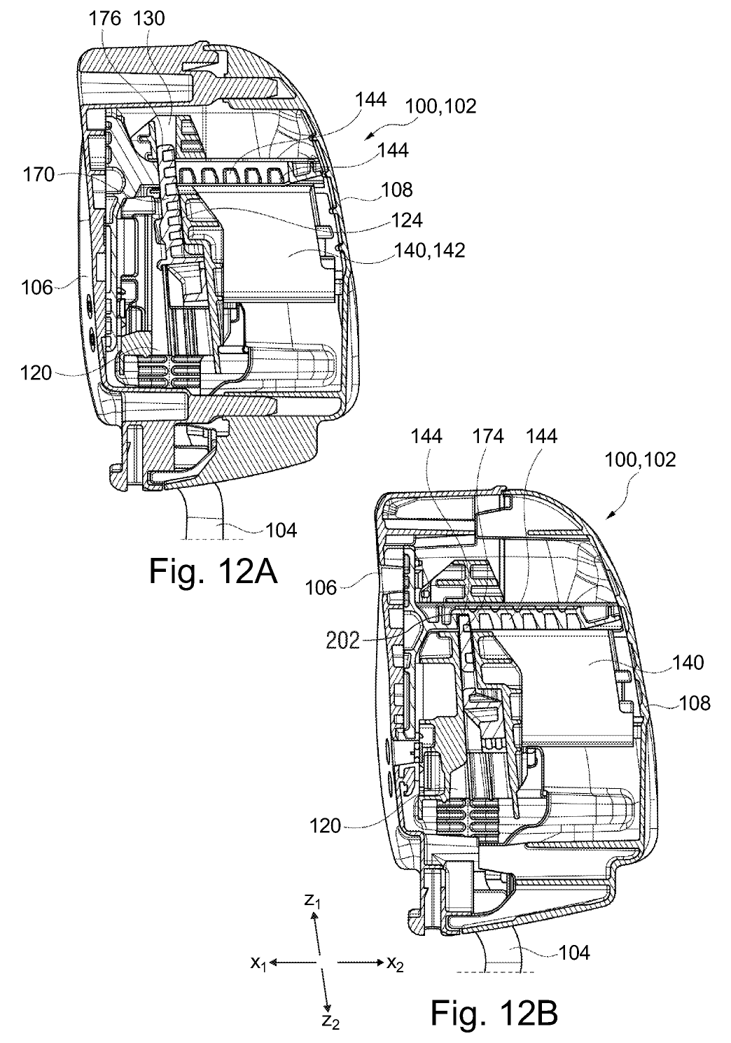

The at least one locking pin 176 can be arranged, for example, parallel to the at least one tooth 174 and adjacent to the latter. In particular, the at least one locking pin 176 and the at least one tooth 174 are formed integrally, in particular as an integral locking element 170. Thus, the locking element 170 with a double locking mechanism, in particular a first locking mechanism 200 by means of the locking pin 176 on the base 120 (illustrated in FIG. 9) and a second locking mechanism 202 by means of the tooth 174 on the slide part 140 (illustrated in FIG. 12B), is designed in a manner that is simple, saves installation space and is optimized for assembly.

Additionally, the base 120 has a linear guide 124 (also illustrated in FIG. 8) in which the locking element 170 is movably guidable or guided. Preferably, the at least one guide opening 122 and the linear guide 124 are arranged to be mutually perpendicular. In other words: The at least one guide opening 122 extends in the longitudinal direction x, in particular in the direction of movement x₁, x₂, and the linear guide 124 extends perpendicularly thereto in the vertical direction z, in particular in the locking direction z₁ or the unlocking direction z₂.

In this instance, the linear guide 124 can be arranged centrally in the at least one guide opening 122, in particular in a U-shaped guide opening (not illustrated) or between the two guide openings 122.

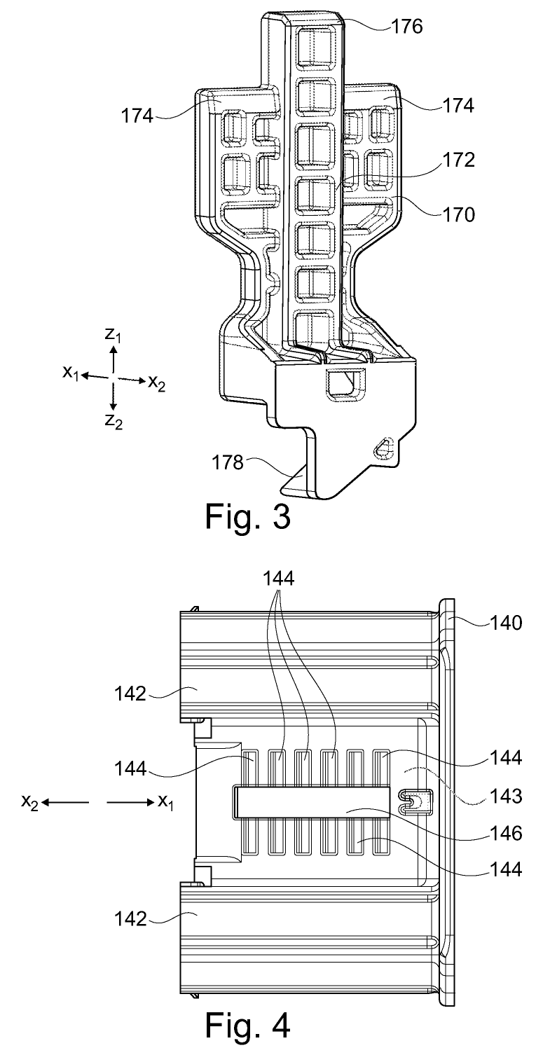

As shown in FIG. 3, the locking element 170 has a main body 172 which is guided in the linear guide 124 of the base 120. The locking element 170 moreover has two teeth 174 and a locking pin 176. The two teeth 174 and the locking pin 176 project from the main body 172. The locking pin 176 is arranged centrally between the two teeth 174. The locking pin 176 projects, in particular upwards, beyond the two teeth 174. The locking element 170 has a ramp 178 on its lower side. The ramp 178 extends obliquely to the unlocking direction z₂.

As shown in FIG. 4, the locking device 160 moreover has two rows of latching depressions 144 for interacting with the teeth 174 of the locking element 170, and a recess 130 (shown in FIG. 10) for interacting with the locking pin 176. The latching depressions 144 are formed in the slide part 140, preferably in a web 143 of the slide part 140 that connects the two guide parts 142 to one another. The web 143 is arranged in a slot 123 (shown in FIG. 8) which connects the two guide openings 122 to one another. The recess 130 is formed in the base 120.

The slide part 140 has a through hole 146 embodied as an elongate bore. The through hole 146 is presently arranged in the web 143. In the locked state of the locking device 160, the locking pin 176 protrudes through the through hole 146 of the slide part 140, wherein the main body 172 is arranged below the through hole 146 and the at least one locking pin 176 is arranged at least partially above the through hole 146.

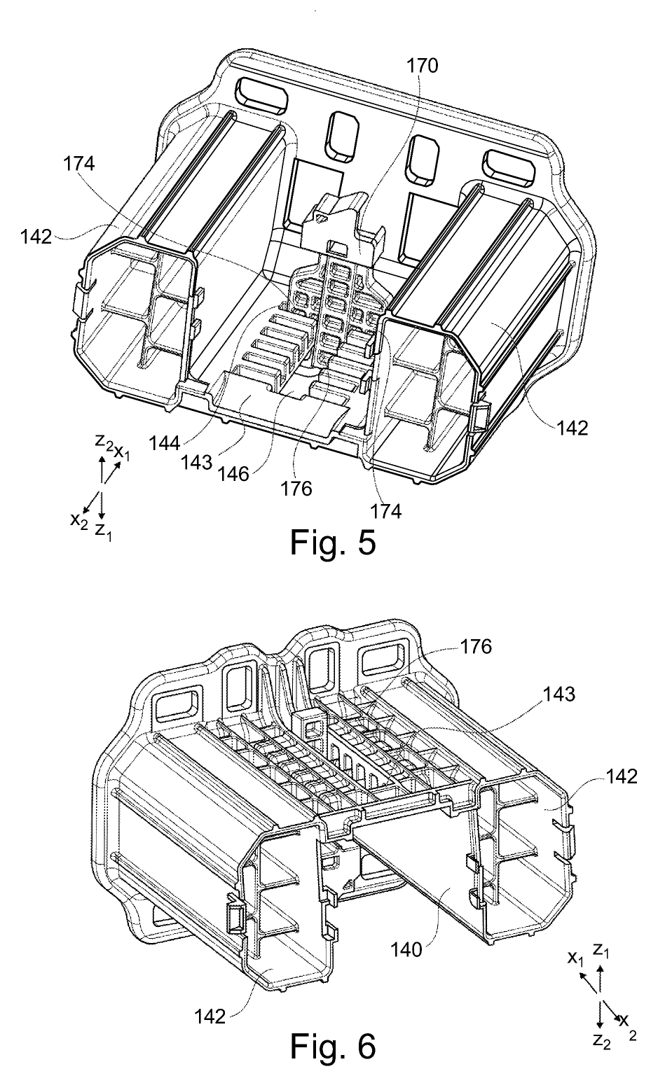

FIGS. 5-7 show the locking device 160 in the locked state, wherein the two teeth 174 each engage in one of the latching depressions 144, and the locking pin 176 engages in the recess 130 of the base 120. As a result, the locking element 170 is received, in particular in the second direction of movement x₂, below the through hole 146 in a form-fitting manner in the linear guide 124 and above the through hole 146 in a form-fitting manner in the recess 130. The locked state of the locking device 160 is illustrated in FIGS. 12A and 12B, wherein the head support part 106 is shown in a rear position in FIGS. 12A and 12B. The sectional profiles of the sectional illustrations in FIGS. 12A and 12B are illustrated in FIG. 11. In FIG. 12A, the locking element 170 is in the locked state and forms the second locking mechanism 202 with the slide part 140.

For unlocking the locking device 160, the locking element 170 has the ramp 178. An unlocking element which is not illustrated in the figures, but known from WO 2019/238516 A1, and is preferably mounted in the base 120, serves to move the locking element 170 in the unlocking direction z_{2.}

FIG. 8 shows the base 120 with the linear guide 124 for guiding the locking element 170. The two guide openings 122 are connected to one another by the slot 123. The guide openings 122 are designed for receiving the guide parts 142 of the slide part 140.

FIG. 9 shows in a perspective view and FIG. 10 shows in a sectional view the base 120 with the locking element 170, without the slide part 140. The locking element 170 is in the locked state and forms the first locking mechanism 200 with the base 120. Here, the locking pin 176 of the locking element 170 protrudes into the recess 130 of the base 120.

An activation button for moving the unlocking element relative to the base 120 in an activation direction, preferably a transverse direction, can be arranged on the unlocking element. The ramp 178 extends obliquely to the activation direction. A restoring spring, for example for resetting the activation button and/or the unlocking element counter to the activation direction, can be provided.

When the unlocking element is moved from an initial position in the activation direction, a contour of the unlocking element first comes into contact with the ramp 178, so that the ramp 178, and conjointly with the latter, the locking element 170, is displaceable downwards in the unlocking direction z₂ by this contour in the further course. As a result, the teeth 174 disengage from the latching depressions 144 and the locking pin 176 disengages from the recess 130. By displacing the locking element 170 in the unlocking direction z₂, the locking device 160 is thus transferable to the unlocked state.

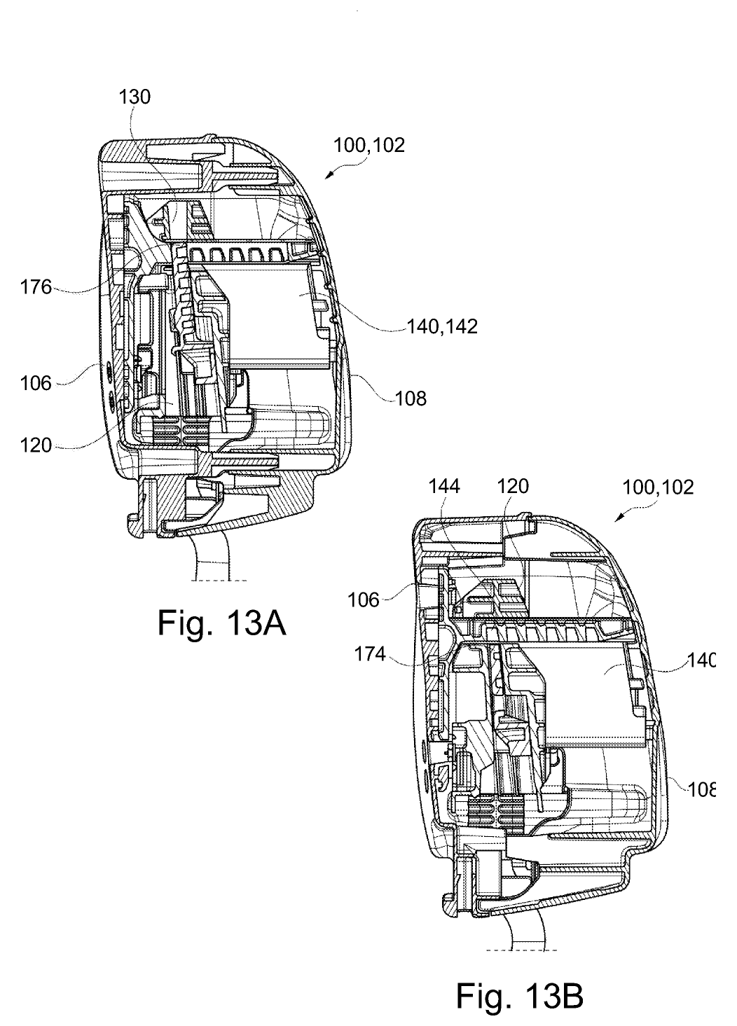

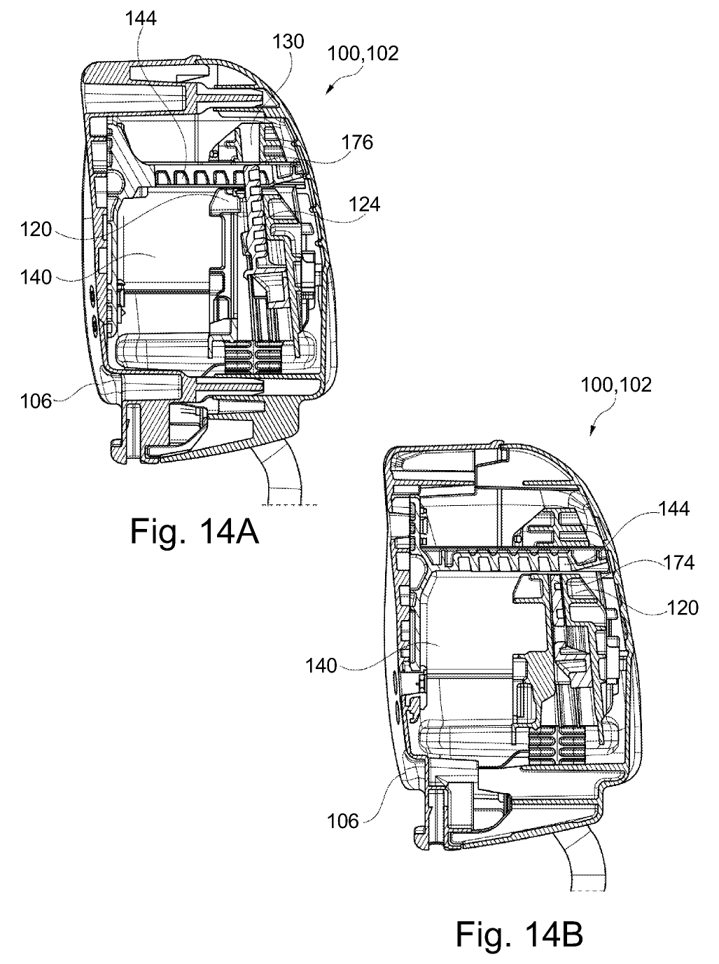

In the unlocked state of the locking device 160, the slide part 140 of the head restraint 102 is displaceable relative to the base 120 in the first direction of movement x₁ and/or the second direction of movement x₂. The unlocked state of the locking device 160 is illustrated in FIGS. 13A, 13B, 14A and 14B, wherein the head support part 106 is shown in a rear position in FIGS. 13A and 13B, and in a front position in FIGS. 14A and 14B. The sectional profiles of the sectional illustrations in FIGS. 13A, 13B, 14A and 14B are illustrated in FIG. 11.

When the unlocking element is no longer activated, the restoring spring will move the former back to its initial position, counter to the activation direction. The ramp 178 of the locking element 170 is no longer impinged by the unlocking element, so that a locking spring moves the locking element 170 in the locking direction z₁, wherein the teeth 174 engage again with the latching depressions 144 and the locking pin 176 engages again with the recess 130. By displacing the locking element 170 in the locking direction z₁, the locking device 160 is transferable back to the locked state.

The contours of the teeth 174 and of the latching depressions 144 can be conceived, in particular bevelled, in such a manner that the slide part 140 can be moved in the first direction of movement x₁ (forward) by an application of force, even without activation of the unlocking element in the first direction of movement x₁, in that the teeth 174 are pushed out of the latching depressions 144 under the application of force by way of appropriately designed slopes and drop into the subsequent latching depression 144 due to the force of the locking spring. In this case, the slide part 140 is lockable by means of the locking device 160 in only one direction of movement, specifically in the second direction of movement x₂ (towards the rear).

The features disclosed in the above description, the claims and the figures can be of importance both individually and in combination for the realization of the invention in its various embodiments, provided that they remain within the scope of the claims.

### LIST OF REFERENCE SIGNS

10 Vehicle seat
13 Backrest
15 Seat part
100 Equipment part
102 Head restraint
104 Holding device
104.1, 104.2 Head restraint bar
106 Head support part
108 Lid
120 Base
120.1, 120.2 Holding opening
122 Guide opening
123 Slot
124 Linear guide
130 Recess (for locking pin 176)
140 Slide part
142 Guide part
143 Web
144 Latching depression
146 Through hole (elongate bore)
160 Locking device
170 Locking element
172 Main body
174 Tooth
176 Locking pin
178 Ramp
200 First locking mechanism
202 Second locking mechanism
x Longitudinal direction
x₁ First direction of movement
x₂ Second direction of movement
z Vertical direction
z₁ Locking direction
z₂ Unlocking direction

What is claimed is:

1. An equipment part for a vehicle seat, wherein the equipment part has a base and a slide part which is movable relative to the base in at least one direction of movement,
wherein the slide part is lockable in at least two positions relative to the base in at least one direction of movement by means of a locking device, the locking device having a locking element which has at least one tooth and is movable relative to the base, and at least two latching depressions which are formed on the slide part or fastened to the slide part, wherein, in a locked state of the locking device, the at least one tooth engages in one of the at least two latching depressions and, in an unlocked state of the locking device, the at least one tooth is disengaged from the latching depressions,
characterized in that
the locking element, in addition to the at least one tooth, has at least one locking pin, and the base has a recess corresponding to the at least one locking pin, wherein, in the locked state of the locking device, the at least one locking pin is arranged in the recess, and in the unlocked state of the locking device, the at least one locking pin is arranged outside the recess.

2. The equipment part according to claim 1, characterized in that the at least one locking pin is arranged parallel to the at least one tooth and adjacent to the latter.

3. The equipment part according to claim 1, characterized in that the base has at least one guide opening in which the slide part is movably guidable or guided.

4. The equipment part according to claim 1, characterized in that the base has a linear guide in which the locking element is movably guidable or guided.

5. The equipment part according to claim 4, characterized in that the guide opening and the linear guide are arranged so as to be mutually perpendicular.

6. The equipment part according to claim 4, characterized in that the linear guide is arranged centrally in the at least one guide opening or between two guide openings.

7. The equipment part according to claim 4, characterized in that the locking element is guided in the linear guide of the base so as to be longitudinally displaceable in a locking direction and in an unlocking direction counter to the locking direction, wherein by displacing the locking element in the locking direction, the locking device is transferable to the locked state, and by displacing the locking element in the unlocking direction, the locking device is transferable to the unlocked state.

8. The equipment part according to claim 4, characterized in that the locking element has a main body which is guided so as to be longitudinally displaceable in the linear guide of the base, the slide part has a through hole, and the locking element, at least in the locked state of the locking device, protrudes through the through hole of the slide part in such a manner that the main body is arranged on one side of the through hole, and the at least one locking pin is at least partially arranged on an opposite side of the through hole.

9. The equipment part according to claim 1, characterized in that the locking element has a plurality of teeth.

10. The equipment part according to claim 9, characterized in that each of the teeth is assigned exactly one row of a plurality of rows of latching depressions.

11. The equipment part according to claim 1, characterized in that the at least one locking pin protrudes through a through hole, wherein at least one row of a plurality of rows of latching depressions is in each case arranged on both sides of the through hole.

12. The equipment part according to claim 1, characterized in that the at least one locking pin is arranged centrally between a plurality of teeth.

13. The equipment part according to claim 1, characterized in that the at least one locking pin protrudes beyond the at least one tooth.

14. A head restraint, embodied as the equipment part according to one of claim 1, characterized in that the base is fixable to a backrest of the vehicle seat by a holding device comprising two head restraint bars.

15. The head restraint according to claim 14, characterized in that the slide part is connected to a head support part.
